(19) United States
(12) Patent Application Publication
(10) Pub. No.: US 2003/0206545 A1
(43) Pub. Date: Nov. 6, 2003

(54) Method for subscriber administration in a variety of telecommunications networks, and telecommunications systems for carrying out the method

(76) Inventors: Thomas Brumm, Gauting-Koenigswiesen (DE); Udo Klotz, Neuried (DE); Norbert Loebig, Darmstadt (DE); Walter Zinkl, Wien (DE); Patrick Kleiner, Muenchen (DE); Robert Kresnik, Slovenska Bistrica (SI); Irena Romanski, Egling (DE)

Correspondence Address: BELL, BOYD & LLOYD, LLC, P. O. BOX 1135, CHICAGO, IL, 60690-1135, US

(21) Appl. No.: 09/827,417

(22) Filed: Apr. 6, 2001

(30) Foreign Application Priority Data
Apr. 6, 2000 (DE) 10017225.3

(51) Int. Cl. H04L 12/66

(52) U.S. Cl. 370/352; 370/401

(57) ABSTRACT

A method and telecommunications system for subscriber administration in a variety of telecommunications networks, wherein first setting information for a first subscriber of a line-switching communications network and second setting information for a second subscriber of a packet-switching communications network are generated using a controller. The first setting information is transmitted between the controller and at least a first control unit of the line-switching communications network, and the second setting information is transmitted between the controller and at least a second control unit of the packet-switching communications network. Using the transmitted setting information, the first control unit sets service features and other features at the first subscriber and the second control unit sets service features and other features at the second subscriber.

### BACKGROUND OF THE INVENTION

The present invention relates to a method for subscriber administration in a variety of telecommunications networks, in which first service features and other features are made available to a first subscriber to a line-switching communications network using the line-switching communications network. Second service features and other features are made available to a second subscriber to a packet-switching communications network using the packet-switching communications network. Service features and other features can be set at the first subscriber using a first control unit of the line-switching communications network. Service features and other features can be set at the second subscriber using a second control unit of the packet-switching communications network.

There are various types of communications networks for transmitting voice, video data and further data. Different services and features have been developed for each of these communications networks by virtue of the various ways in which these communications networks can be used. Conventional communications networks for the transmission of voice are generally line-switching communications networks and communications networks for transmitting other data are usually packet-switching communications networks; for example, a local computer network (Local Area Network; LAN) or the Internet. However, at present voice, data and video services of both types of communication network can be made available. It is therefore possible, for example, to connect a subscriber to the line-switching communications network via a packet-switching communications network. Supplementary services such as call pick-up, three-way conferencing, large-scale conferencing, holding, displaying of toll information, closed user group, call number identification, automatic call-back when busy, automatic call-back when no reply, call barring, call waiting and call forwarding which are made available in known line-switching communications networks also can to a certain extent, be used in packet-switching communications networks. Standards, for example in the series of the Recommendations of the International Telecommunication Union Telecommunications Standardisation Sector (ITU-T Recommendation) based on the H.323, are defined for packet-switching communications networks. These standards include, in particular, the Standards H.323, H.225 and H.450.

An H.323 architecture for supplementary services in which there is a possibility of interaction of the services between line-switching and packet-switching communications networks is also known. For example, it is known that user-channel-related signaling messages for activating, deactivating, requesting and controlling services and features in the line-switching communications network are mapped onto signaling packets which are used in the packet-switching communications network. Preferably, “DSS 1 messages” which are defined in the ITU Standards Q.931 and Q.932 are used in the line-switching communications network. Preferably, the standardized H.225 signaling protocol is used for transmitting the signaling packets in the packet-switching communications network, in particular over the Internet. Service features and features which, to be used, require user-channel-related signaling messages are, for example, call pick-up, three-way conferencing and large-scale conferencing, holding, displaying of toll information, closed user group and call number identification services. Signaling which is independent of a user connection or a user channel is necessary for status interrogations and for activating or deactivating service features; for example, call divert, automatic call-back when busy, automatic call-back when no reply and call waiting.

Components such as terminals, gateways and gatekeepers are provided and defined for transmitting voice according to the H.323 Standard. Terminals are terminating devices which are connected to the packet-switching communications network. In packet-switching communications networks it is necessary for the subscriber to log on with his terminal. A gateway is used as an interface for converting the data protocols between the packet-switching communications network and the line-switching communications network. A gatekeeper is used to administer and to check user services and network capacities of a packet-switching communications network according to the H.323 Standard. The addressing of an incoming call also takes place in the gatekeeper in the packet-switching communications network. Each subscriber has an address in the packet-switching communications network. The telephone number which is selected by a calling subscriber is converted by the gatekeeper to the address of the subscriber in the packet-switching communications network. In this way, the H.323 Standard can be used to transmit telephone calls over the Internet and in networks based on an Internet protocol.

Large packet-switching communications networks enable a number of employees to avoid the need to work in the same office, or to work in the same office continuously. This is the case, in particular, if employees have to travel often or work as teleworkers at home. These employees are then connected to an external data network; for example, the Internet. This Internet then provides these employees with access to the internal data network of the company, for example an Intranet and to the voice network of the company. Employees who are working, for example, for a department or on a project, are combined into groups, “CENTREX” groups, in particular for the sake of better accessibility. CENTREX is a special service which is made available using a network node or using a number of network nodes of a telecommunications network. CENTREX can be used to provide some of the connected subscribers, for example the employees of the department or of the project, with a range of functions corresponding approximately to the range of functions of a private branch exchange, even though they are not connected to a private branch exchange. Using the CENTREX service it is possible, for example, for an incoming call for one employee in the group to be made visible and available to other preset subscribers. Thus, with the CENTREX service there is also the possibility of presetting a team call or a call pick-up. Here, when there is an incoming call to a subscriber line in the group a message is generated which is transmitted to the other subscriber lines which are preset in this group. Each subscriber to the group can then receive this call. Each of the subscribers in the group can also receive calls parked in the system. The subscribers to the CENTREX group can also have a common call number schedule which can be used by all the subscriber lines. However, in the prior art, it is possible to use the CENTREX service and other services known on voice connections, such as three-way conferencing, call transfer, call play-back, subscriber cut-in, recorded announcement services and private call number schedule, only in a line-switching communications network. According to the H.323/H.450 Standard, these services are not supported for voice connections using the packet-switching communications network, or not to the same extent.

The administration of the subscribers and the administration of the services and of the features of the subscribers is carried out in the prior art using control units of the packet-switching communications network for subscribers to packet-switching communications networks, and using control units of the line-switching communications network for subscribers to the line-switching communications network. The administration of the subscribers and the administration of the services and features made available to the subscribers are generally referred to as subscriber administration.

In the prior art, a subscriber to a line-switching communications network must be logged on and administered both in a connection controller and in a service feature and feature controller. This is carried out using two separate program modules which are processed on an administration computer of the telecommunications system. The administration of some features, for example the administration of CENTREX groups, requires further program modules which are used to administer the respective feature for the respective subscriber. These program modules are executed on different service computers. In the event of a change to a feature for which it is also necessary to adapt the connection controller, it is necessary in the prior art for settings to be made in two different program modules. These program modules do not exchange any data with one another and usually have different user interfaces. As a result, not only is complex training of operators necessary but also double input of subscriber data. Furthermore, the data items which are input must be matched to one another because otherwise errors and faults can occur. Administration using these different program modules is usually carried out in the prior art from a central location of the network operator, the administration data being transmitted from the individual program modules to the switching offices which carry out the connection control and the control of the features for the subscriber.

Subscriber administration of subscribers to packet-switching communications networks is carried out in a way similar to the subscriber administration of subscribers to a line-switching communications network. For example, the access rights of subscribers who dial into the packet-switching communications network using a dialed connection are administered and monitored using a “RADIUS” server, and the administration of the connection controller and of the features is performed using a gatekeeper. RADIUS servers (remote authentication dial-in user) are used for remote identification of users who dial into the packet-switching communications network using a line-switching communications network, for example. In order to make available services and features for such a subscriber, it is also necessary in the packet-switching communications network to make settings for subscriber administration in two different program modules, these program modules usually having different user interfaces and not being connected to one another. Subscriber administration with conventional administration methods is very complex and unwieldy, particularly in the case of subscribers with a number of subscriber lines; for example, in the case of companies whose employees are combined in network-wide CENTREX groups which are connected both to the line-switching communications network and to the packet-switching communications network at different locations with different connection methods.

An object of the present invention, therefore, is to specify a method and a telecommunications system for subscriber administration in different telecommunications networks, in which subscriber administration is possible in a simple and clearly organized way.

### SUMMARY OF THE INVENTION

According to a method for subscriber administration in different communications networks pursuant to the teachings of the present invention, it is possible to administer the subscribers to line-switching communications networks and the subscribers to packet-switching communications networks jointly in a centralized fashion, and to set service features and features of the individual subscribers in a clearly organized way using a uniform user interface. The operators do not need to be informed as to whether individual subscribers are subscribers to the packet-switching communications network or of the line-switching communications network. This is also a way of setting in a simple and clearly organized way services and features for subscribers to the packet-switching communications network which are made available to these subscribers using network elements of the line-switching communications network. The need to train the operators on a number of program modules for subscriber administration and to reconcile data between these program modules is dispensed with. The subscriber administration can be carried out from a central location of the network operator.

The setting information is transmitted using the administration connections provided in the respective communications networks. Such a connection is, for example, an X.25 connection or an IP connection with file transfer (FTP connection).

In an embodiment of the present invention, the controller is a super-ordinate controller of the first and second control units. This ensures that the first and second control units set the service features and other features in accordance with the setting information of the controller.

In another embodiment of the present invention, the subscriber signaling of the second subscriber is carried out using a network element of the line-switching communications network. The network element has an interface to the packet-switching communications network. In this way, services and features of the line-switching communications network can be made available to the second subscriber to the packet-switching communications network. These service features and other features also can be administered and configured using the controller. The services and features of the packet-switching communications network continue to be made available to the second subscriber and likewise can be set and configured using the controller.

In one embodiment of the present invention, the services and features of the line-switching communications network include call pick-up, call divert, call name display, subscriber cut-in, subscriber-dependent ringing, three-way conferencing, large-scale conferencing, holding, displaying of toll information, closed user group, private number schedule, call number identification, automatic call-back when busy, automatic call-back when no reply, call barring, call waiting and/or call transfer. This ensures that important services and features can be administered and configured using the method for subscriber administration.

According to one further embodiment of the present invention, the second setting information generated using the controller includes an alias name, gatekeeper administration, call waiting and/or authorization for subscribers to carry out the configuration of their subscriber features themselves via the Internet. The controller can, thus, administer and configure important services and features of the packet-switching communications network for the second subscriber. The necessary settings for this are carried out in a gatekeeper and/or RADIUS server automatically using the setting information generated by the controller.

In one advantageous embodiment of the present invention, settings in a number of control units of the line-switching and/or of the packet-switching communications network are necessary to set a service or feature. The corresponding setting information is generated by the controller and transmitted to the respective control units. This ensures that the controller automatically carries out all the necessary settings without further user interventions. Errors owing to incorrect or contradictory settings in the control modules of the control units are thus precluded.

In another advantageous embodiment of the present invention, the subscriber signaling is carried out in accordance with an H.323/H.450 signaling protocol in the packet-switching communications network and in accordance with a DSS 1 signaling protocol in the line-switching communications network. This ensures that services and features which are customary and widespread in telecommunications in line-switching and packet-switching communications networks are administered and configured using the controller. However, the method also can be used in communications networks with other signaling protocols such as the SIP signaling protocol.

According to another advantageous development, the packet-switching communications network is a data network which is based on an Internet protocol. Such a data network which is based on an Internet protocol is, for example, the Internet or a local data network (LAN). Owing to the widespread prevalence of such networks, they are also increasingly being used for telecommunications. Subscriber administration using the method is also possible without a large degree of expenditure for subscribers to these networks.

According to one advantageous embodiment of the present invention, the controller of an input unit and of an output unit can be used to input/output setting information for administering the service features and features. It is advantageous here if the controller makes available a graphic user interface for inputting and outputting data. Selection lists of the graphic user interface can be used to activate, deactivate and/or configure these services and features. The selection lists for activating, deactivating and/or configuring the services and features of a subscriber show only the services and features which can be set for the respective subscriber. This ensures that simple operation is easily possible even for operators with an average level of training and errors are avoided by automatic adaptation of the selection lists in accordance with the subscriber properties. The operators do not need to be informed as to whether the individual subscriber is a subscriber to the packet-switching communication network or a subscriber to the line-switching communications network. As a result, operators can be trained quickly. The need to train on different, partially decentralized administration systems is dispensed with.

In another embodiment of the present invention, the controller has access to a database with subscriber information of the first and second subscribers. The controller and the database can be operated in accordance with a client-server principle. The address parameters, for example, are then stored in the database. These address parameters can be a local address code, i.e. a dialing code, a directory number, i.e. a call number, a switch address, i.e. a switching office address, and an IP alias name of the second subscriber. The access to this database, which may be, for example, a central database of the network operator or of a network element, is carried out using a standardized program interface; for example, a COBRA interface or an SNMP interface. In this way, to exchange the data the controller makes use of a known interface which is effective and widespread in telecommunications systems. This interface may be capable of being replaced in the controller or a number of interfaces may be available in the controller so that different interfaces for exchanging data are available to the controller. In this way, the controller can be inserted into existing communications systems in a simple and uncomplicated way. The controller also can make use of simple, existing components, for example databases, of the telecommunications network.

In a further advantageous embodiment of the present invention, the setting information is transmitted using a program interface between the controller and the control units. Existing program interfaces of the control units can, thus, be used easily by the controller, as a result of which the expenditure in order to install the controller is reduced because it is not necessary to adapt the existing control units. The program interfaces of the controller can be replaced. Furthermore, a number of program interfaces can be activated in the controller so that the controller can be individually adapted to the existing control units without a large degree of expenditure. Such program interfaces may be, for example, a Q3 interface or an interface based on man/machine language.

In addition, it is advantageous for a number of subscribers to be assigned to one group in the controller, it being possible to assign services and features to the group. These subscribers may be either subscribers to the line-switching communications network or subscribers to the packet-switching communications network. This ensures that, for example, subscriber lines of a company can be administered in a clearly organized way, in which case it is possible both to configure individual features for individual subscriber lines and to configure features jointly for subscriber groups or for all subscriber lines. The subscribers can be connected here to different switching offices of the packet-switching communications network and/or of the line-switching communications network. In this way, clearly organized administration of all the subscribers is possible from all the locations in a company in a simple and clearly organized way using the controller. Private subscriber lines of the employees of the company also can be included in this administration in an uncomplicated way. This is appropriate and advantageous, in particular, in the case of subscriber lines of “teleworkers”. Using the controller also makes it possible to assign different subscribers to a “CENTREX” group and to administer the common service features and features of this CENTREX group easily using the controller. The subscribers to the CENTREX group can be subscribers to the line-switching communications network and/or of the packet-switching communications network here. In this way, intra-network subscriber administration is easily possible using a single controller.

Subscriber administration for subscribers to different communications networks is easily possible in an uncomplicated way using a telecommunications system for subscriber administration in different subscriber networks having the features of patent claim 23. The necessary settings in individual network components of the respective network are carried out automatically by the controller. The controller automatically carries out plausibility checks, it being possible for the controller to be configured in such a way that an operator is provided with only the setting facilities which are technically and administratively possible for the subscriber. Central administration of subscribers to the packet-switching communications network and of the line-switching communications network is thus easily possible. An operator is provided with a uniform operating interface using the controller. The controller does not need to be informed that the first subscriber is a subscriber to the line-switching communications network and that the second subscriber is a subscriber to a packet-switching communications network because for the operator the subscriber administration is carried out independently of the network. The need to train the operator in a wide variety of partially decentralized administration systems is dispensed with. The possibility of errors as a result of contradictory configurations of individual network elements and/or features is dispensed with because of the uniform administration using the controller.

Additional features and advantages of the present invention are described in, and will be apparent from, the following Detailed Description of the Invention and the Figures.

### BRIEF DESCRIPTION OF THE FIGURES

FIG. 1 shows a telecommunications system with network elements of a line-switching communications network and of a packet-switching communications network, as well as of a central controller for subscriber administration.

FIG. 2 shows a graphic user interface for selecting business customers of a network operator.

FIG. 3 shows the graphic user interface with a setting facility for subscribers of the business customer.

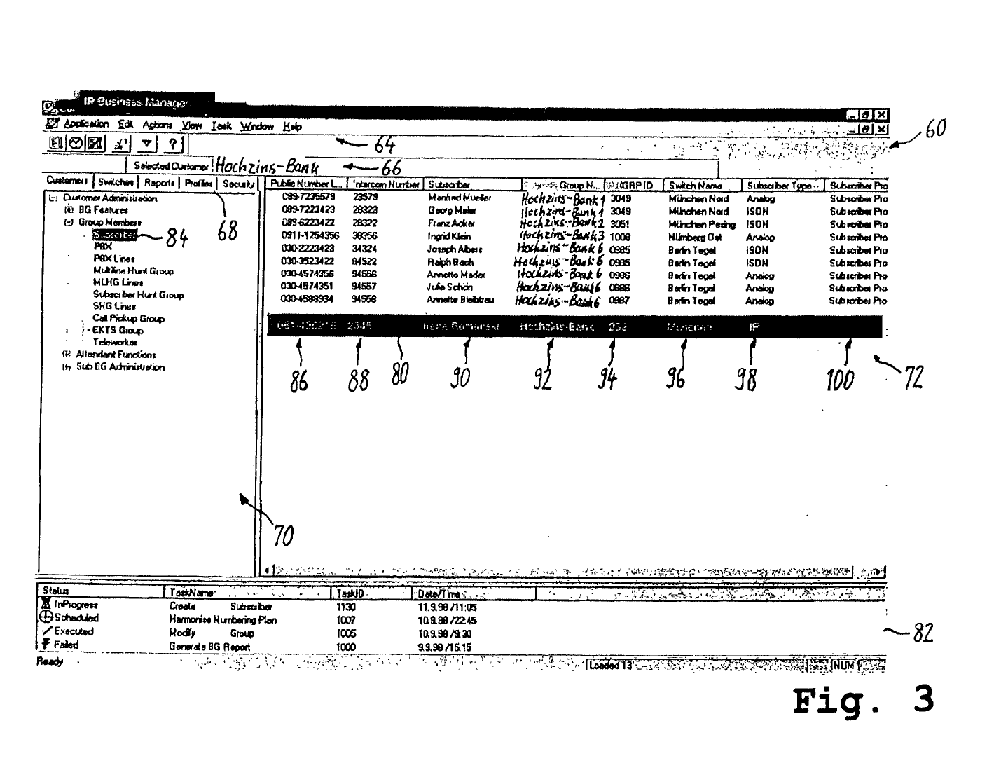

FIG. 4 shows the graphic user interface with a setting facility for individual features of a selected subscriber.

FIG. 5 shows the graphic user interface with a setting facility for automatically updating number schedules.

FIG. 6 shows the graphic user interface with a setting facility for access codes for activating and deactivating features via the individual subscribers.

FIG. 7 shows a block circuit diagram in which the interaction of the controller with the control units of the line-switching communications network and of the packet-switching communications network, as well as with the network elements of these networks is shown.

### DETAILED DESCRIPTION OF THE INVENTION

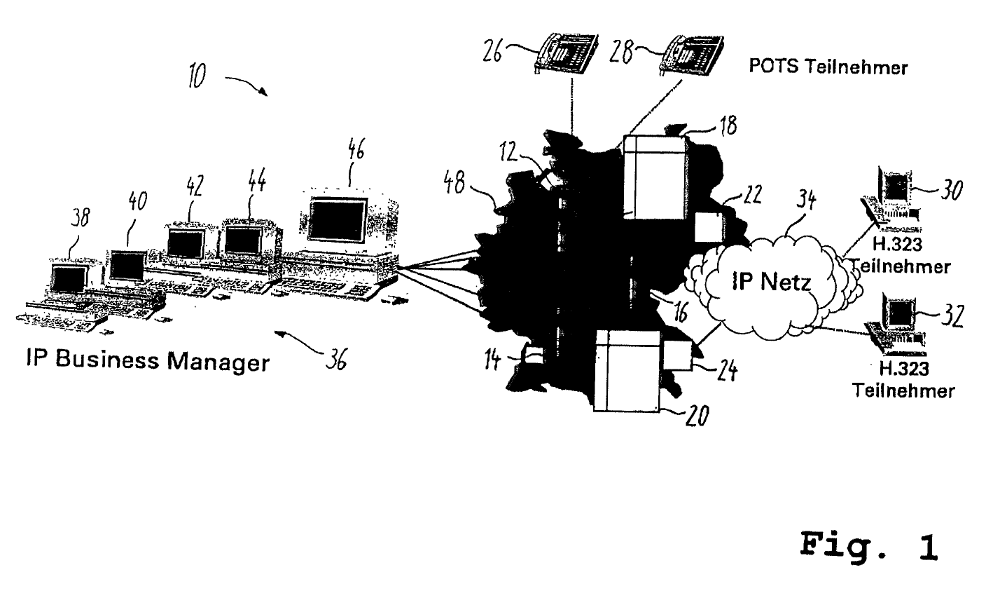

FIG. 1 illustrates a telecommunications system 10 for subscriber administration in various telecommunications networks. The telecommunications system 10 has network elements 12, 14, 16 of a line-switching communications network; for example, switching offices 12, 14, 16 of the public telephone network 48. These switching offices 12, 14, 16 are connected to one another by connecting lines (not illustrated) and form the public telephone network 48. Subscribers, of whom two telephone subscribers 26, 28 are illustrated, are connected to each of these switching offices 12, 14, 16. The telecommunications system 10 also has network elements 18, 20 with IP functions. Such network elements 18, 20 are, for example, SURPASS network elements from Siemens AG. These network elements 18, 20 can carry out both the subscriber signaling for subscribers 26, 28 of the telephone network 48 and for subscribers 30, 32 of a packet-switching communications network 34. The network element 18 is connected to a gatekeeper 22, and the network element 20 is connected to a gatekeeper 24. The gatekeepers 22, 24 are used to control connections and to control service features and features of a data network 34 which is based on an Internet protocol. The data network 34 which is based on the Internet protocol is also referred to as the IP network. The signaling in the IP network 34 is carried out using the H.323 signaling Standard. Two subscribers 30, 32 of the IP network 34 are illustrated, by way of example, for other subscribers. The subscriber administration, i.e. the administration of the subscribers 26 to 32 and their services and features is carried out using a central controller 36. This central controller 36 is also referred to as an IP business manager. The controller 36 has a number of operator terminals 38 to 36. The central controller 36 is connected to the network elements 12 to 20 and to the gatekeepers 22, 24 using administration connections; for example, using X.25 connections. The controller 36 has, in particular, access to the database of the respective network element 12 to 24. The subscribers 30, 32 of the IP network 34 are also provided with services and features of the telephone network 48 in the IP network 34 using the network elements 18, 20 with IP function. In this way, the subscribers 30, 32 are provided not only with the services and features of the IP network 34 but also with those of the telephone network 48. The network elements 12 to 20 and the controller 36 may be arranged at a spatial distance from one another here. In the telecommunications system illustrated in FIG. 1, the network elements 12 to 24 are distributed over the territory of the Federal Republic of Germany. Setting information which is used to configure and administer services and features of individual subscribers 26, 28, 30, 32 of the telephone network 36 and of the IP network 34 is generated using the controller 36.

An operator configures the services and features for the subscribers 26 to 32 using an operator terminal 38 to 40 independently of the communications network 34, 48 to which the subscriber 26 to 32 is connected. The controller 36 generates setting information corresponding to the settings and the configuration of the services and features, said setting information being fed by the controller 36 to the network elements 12 to 24 using the administration connections. If this setting information has to be fed to a number of network elements 12 to 24 in order to set the service or feature, the corresponding setting information is fed to the respective network element 12 to 24 without this having to be brought about in a detailed way by the operator. After the setting or configuration of the service or feature on the operator terminal 38 to 46, the settings of the network elements 12 to 24 are made automatically.

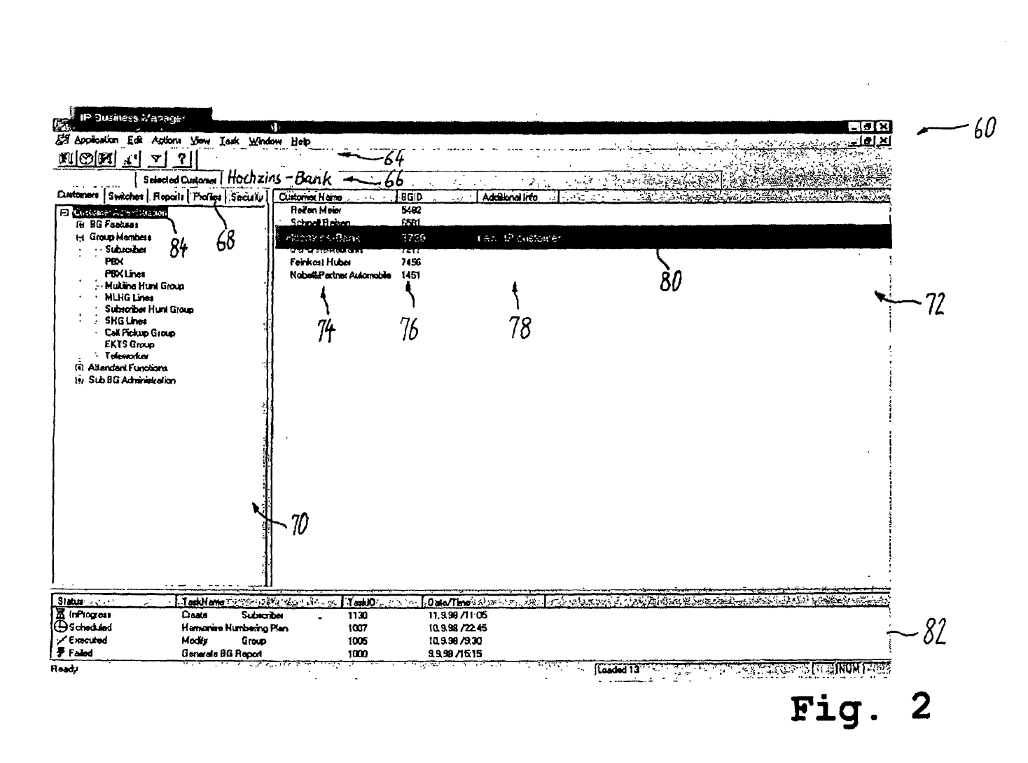

FIG. 2 illustrates a user interface of the controller 36 which is illustrated on one of the operator terminals 38 to 46 of the controller 36. The user interface 60 includes an operator panel 64 with typical control elements of graphic user interfaces such as pull-down menus and buttons. Furthermore, the graphic user interface includes a display area 66, register cards 68, a first selection window 70 for selecting basic subscriber functions, a second selection window 72 for selecting detailed subscriber functions and a status window 82 for displaying the status of operations of the controller 36. The “subscriber administration” register card is selected using the register cards 68.

However, the controller 36 also can be used to carry out settings of the switching offices, settings of acknowledgements, settings of profiles and security settings, other register cards having to be selected for these settings. The selection of the “subscriber administration” register card causes basic subscriber functions to be displayed for selection in the first selection window 70. The “general subscriber administration” is selected using a selection bar 84 in the first selection window 70. The customers administered by the controller 36 are then displayed in the second selection window 72. These customers are company customers with subscriber lines at a number of locations which are administered jointly using the controller 36. These company customers are also referred to as business customers. Each customer forms one subscriber group here.

In the second selection window 72, the names of the subscriber groups are displayed in a first column 74. In a second column 76, the group number of the respective subscriber group is displayed. Supplementary information on the respective subscriber group is noted in the column 78. A subscriber group is selected for further processing using a selection bar 80, which is also referred to as a scroll bar. The “high interest bank” subscriber group with the subscriber group number 3730 is selected using the selection bar 80. The currently selected subscriber group “high interest bank” is displayed in the display area 66.

After the “high interest bank” subscriber group has been selected in FIG. 2, the individual subscribers to this subscriber group are displayed using the user interface 60. After the selection and activation of the “high interest bank” subscriber group using the selection bar 80, the menu item “subscriber” is activated in the first selection window 70 by an operator using the selection bar 84. The subscribers to the “high interest bank” subscriber group are then displayed in the second selection window. The call number of the respective subscriber via which he/she can be accessed on the public telephone network 48 is displayed in a first column 86 of the second selection window 72. The internal call numbers of the subscribers which can be used to access the subscriber within the subscriber group or within a CENTREX group are displayed in a second column 88. The name of the subscriber is presented in a third column 90, and the name of the subscriber group is presented in a column 92.

The number of the CENTREX group to which the subscriber is assigned is illustrated in a fifth column 94. The location of the network element or of the switching office 12 to 24 to which the respective subscriber 28 to 32 is connected or assigned is given in a sixth column 96, the type of the subscriber line of the respective subscriber is given in a seventh column 98, and a description of the subscriber line is given in an eighth column 100. Using the selection bar 80, a subscriber “Irena Romanski” of the “high interest bank” subscriber group is selected in order to display detailed information on this subscriber and to set services and features for the subscriber's subscriber line.

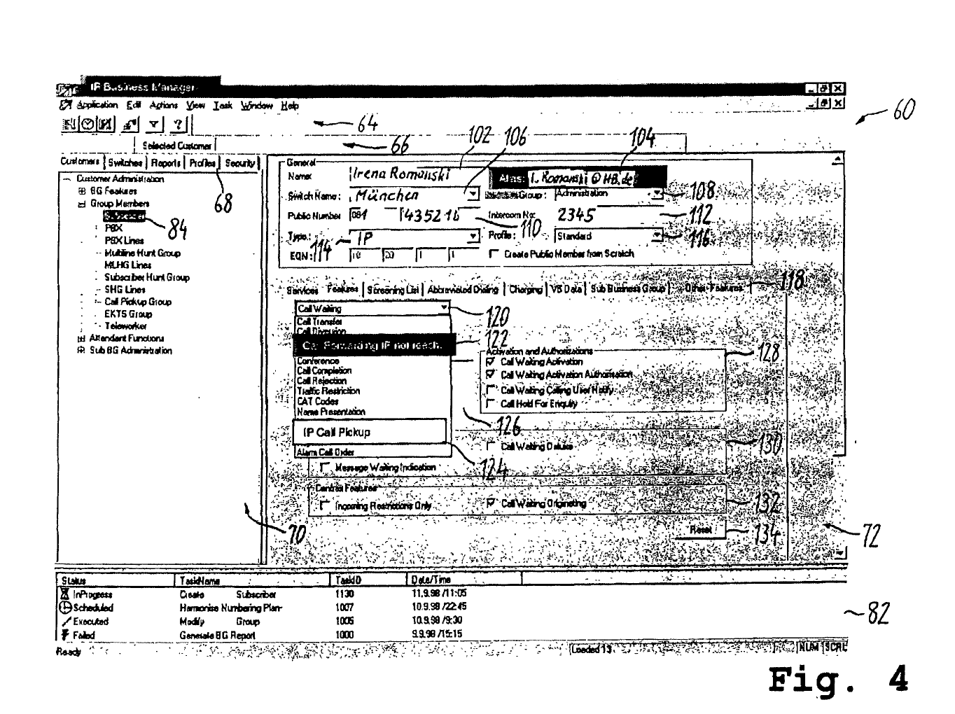

After the subscriber has been selected using the selection bar 80 and the selection bar has been activated, detailed information on the subscriber “Irena Romanski” is displayed in the second selection window 72. This is illustrated in FIG. 4. The detailed information includes a display and input area 102 for the subscriber's name, a display and input area 104 for the alias name of the subscriber line of the subscriber “Irena Romanski” in the IP network 34, a display and input area 106 for the assignment of the subscriber line 26 to 32 to a network element 12 to 24, a display and input area 108 for the assignment of the subscriber line to a subscriber group, a display and input area 110 for displaying and assigning a call number of the telephone network and a display and input area 112 for entering a CENTREX call number of the subscriber “Irena Romanski”.

The type of subscriber line is defined using a display and input area 114. Such a type of subscriber line may be, for example, the “analog” type, the “ISTN” type or the “IP” type for a subscriber to an IP network 34. The display and input area 116 can be used to preset a profile for the subscriber line. Register cards 118 can be used to select further display and input areas with setting facilities for the subscriber line of “Irena Romanski”.

The “features” register card is activated in FIG. 4. A display and input area 120 can be used to activate, deactivate and/or configure the features which are available for the subscriber line. The display and input area 120 is embodied, like the display and input areas 106, 114, 108 and 116, as a “pull-down menu”, it being possible to activate a selection list with possible setting functions by activating the button illustrated as an arrow. A list of features which can be activated for the subscriber line can be displayed in the display and input area 120 using this button.

The subscriber line of “Irena Romanski” is a subscriber line 30, 32 of the IP network 34. The subscriber signaling of the subscriber line 30, 32 is carried out using the network element 18 and the gatekeeper 22. In particular the network element 18 is used to provide the IP subscriber line 30, 32 of “Irena Romanski” not only with services and features of the IP network 34 but also with all the features of the telephone network 48. These services and features include call pick-up, call divert, call forwarding, call name display, subscriber cut-in, subscriber-dependent ringing, three-way conferencing, large-scale conferencing, holding, displaying of toll information, closed user group, private number schedule, call number identification, automatic call-back when busy, automatic call-back when no reply, call barring, call waiting and/or call transfer as well as IP network-specific services and features such as call forwarding with a non-registered IP subscriber and IP call pick-up 124.

The selection bar 122 can be used to activate the features displayed in the selection list. The activated features for the subscriber line 30, 32 are displayed in the display field 126. The “call waiting” feature which is currently activated for configuration is displayed in the display and input area 120. In accordance with the selected feature “call waiting”, possible configuration possibilities of the feature for the subscriber line are illustrated in a display and input area 128. Control fields of the display and input area 128 can be used to set these configuration possibilities in an easy and clearly organized way. Further display and input areas 130, 132 are used to display further selection fields for configuring the “call waiting” feature. The settings which have been made can be reset again to standard settings using a button 134.

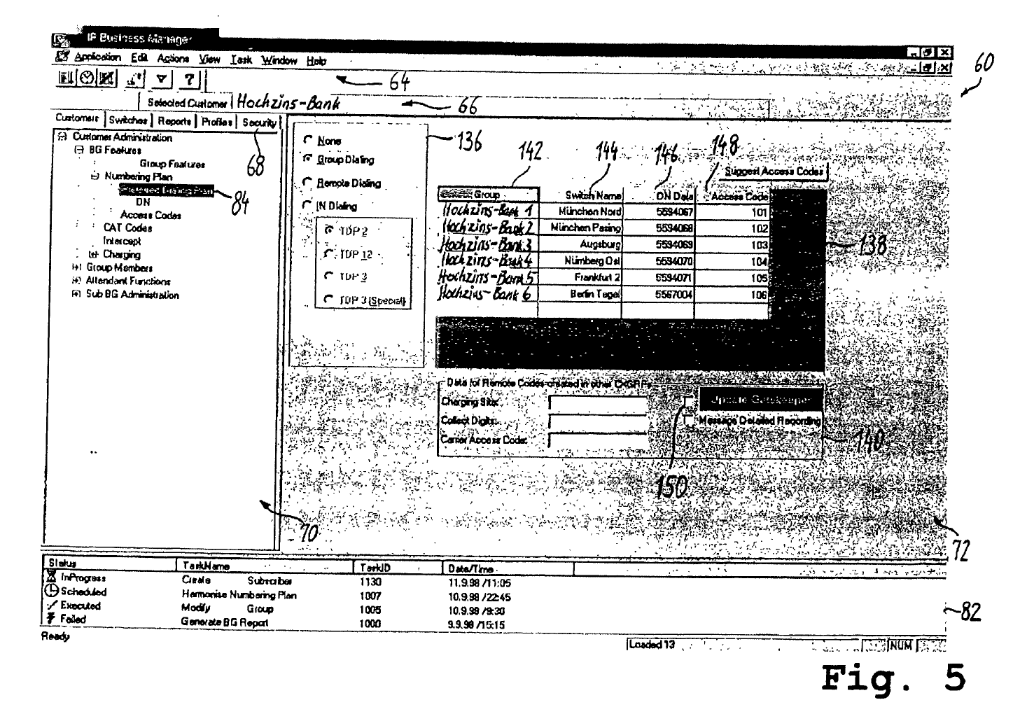

FIG. 5 illustrates the user interface 60, a setting facility for “preferred number schedules” having been selected using the first selection window 70. The number schedules which are available for the preset “high interest bank” subscriber displayed in the display area 66 are displayed in the second selection window 72. Display and input areas 136, 138, 140 are then displayed in the second selection window. Basic settings for the type of number schedules can be selected using the selection window 136. In the present exemplary embodiment, the group-based administration of number schedules has been selected. The number schedules which have been assigned to the network elements 12 to 24 are listed in the display and input area 138. The “high interest bank” subscriber group has a number schedule for six extensions, the “high interest bank 1” number schedule being assigned to the “North Munich” switching office which has the list number (directory number) 5594067 and can be used by subscribers via the access code 101.

The group name is presented in the first column 142, the switching office name in the second column 144, the group call number in the third column 146 and the access code in the fourth column 148 of the display and input area 138. For the groups “high interest bank 2” to “high interest bank 6” the name of the respective network element 12 to 24, the respective group call number and the respective access code are displayed, as was the case with the “high interest bank 1” group.

The group call number can be used by any public subscribers, and the access code can be used by subscribers 26, 28 of the telephone network 48 and subscribers 30, 32 of the IP network 34 to access any of these number schedules. The number schedules used by the subscribers 26 to 32 are stored as a copy in the network elements 12 to 24 which carry out the subscriber signaling of the respective subscriber. For the subscribers 26 and 28 this is the network element 12, for the subscriber 30 the gatekeeper 22 and for the subscriber 32 the gatekeeper 24. If the check field 150 is activated in the display and input area 140, after a call number or an alias name is changed, the copies of the number schedules stored in the gatekeepers 22, 24 and in the network element 12 are automatically updated. The updating is also carried out after the addition of new subscribers or after the deletion of subscribers to the number schedules. The controller 36 automatically checks the data for consistency after input.

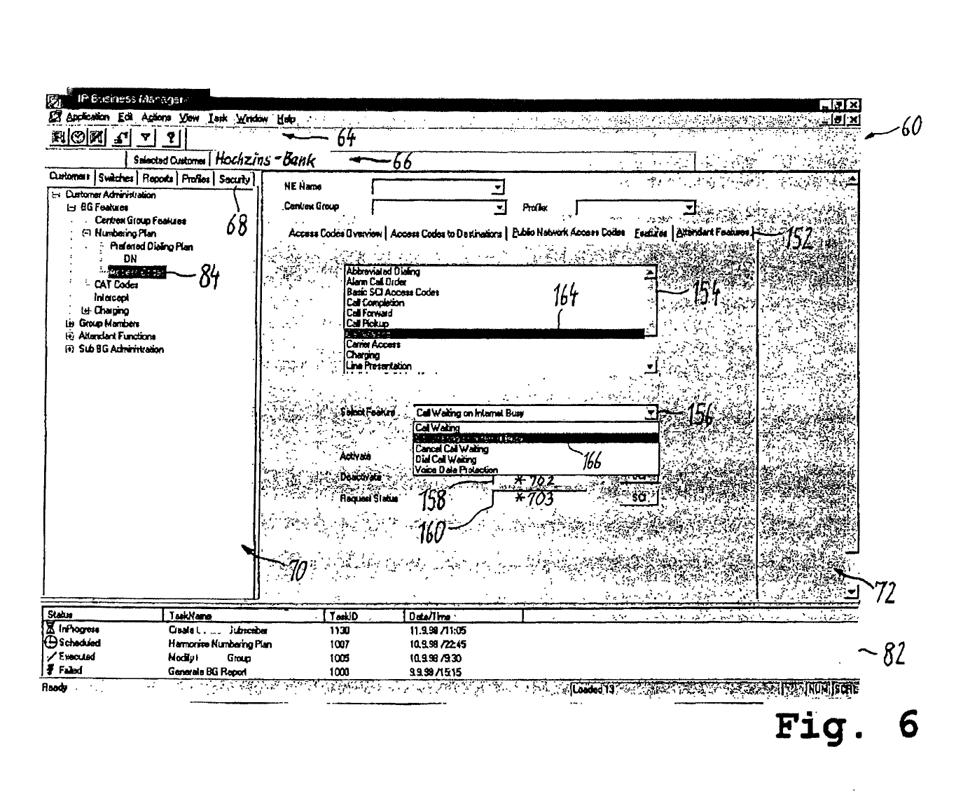

FIG. 6 illustrates the user interface 60, it being possible to use the second selection window 72 to define access codes of the private number schedule for features. Appropriate display and input areas are presented in the second selection window 72. The “features” register card has been selected using a register card selection bar 152. All the feature groups available for the “high interest bank” subscriber group are displayed in a display and input area 154. The selection bar 164 is used to select a “call waiting” feature group. A single feature of the feature group selected in the display and input area 154 can be selected using a selection list of the display and input area 156. The “call waiting when Internet busy” feature which is available in the IP network 34 is selected using the selection bar 166. Control symbols for deactivating the selected feature are defined using the display and input area 158. The control symbols for status interrogation of the feature are defined using the display and input area 160 and a display and input field 162 which is covered by the selection list of the display and input area 156, in order to activate the feature. In the present exemplary embodiment, in order to activate the “call waiting when Internet busy” feature, the control symbols *701 are defined for activation in the input and display field 162 (not illustrated), the control symbols *702 for deactivation in the input and display field 158 and the control symbols *703 for status interrogation in the input and display field 160. In this way, any subscriber can activate and deactivate the “call waiting when Internet busy” feature using the keypad on his terminal by inputting these control symbols, and request the current setting of the feature using status interrogation.

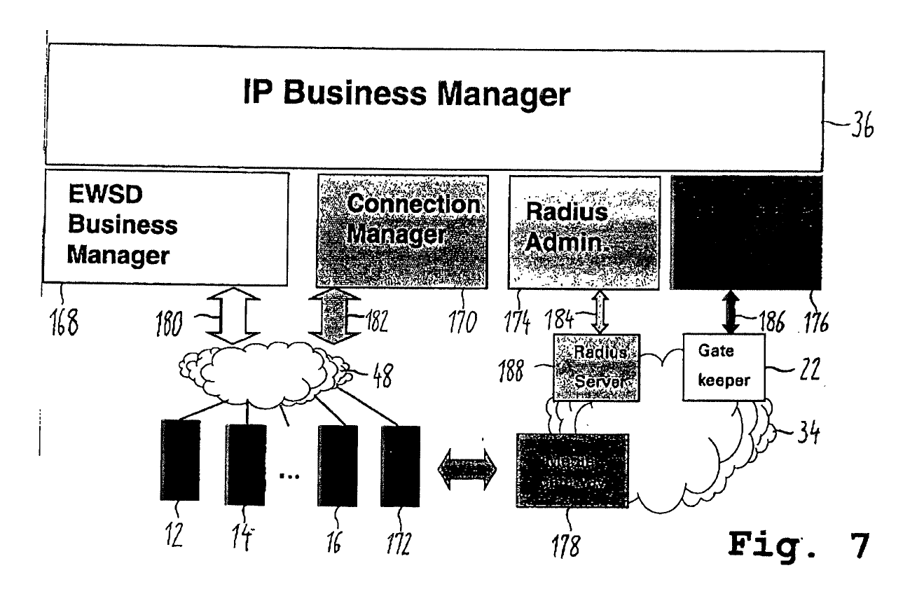

FIG. 7 illustrates a block diagram of the controller 36 and of control units for subscriber administration. The central controller 36 for subscriber administration is connected via program interfaces to a control unit 168 for controlling features of the telecommunications network 48 and to a connection controller 170 of the telecommunications network 48. The control unit 168 is connected using administration channels 180, and the connection controller 170 is connected using administration channels 182. These administration channels 180, 182 are used to transmit to the switching offices 12, 14, 16, 172 of the telecommunications network 48 setting information and the data which is necessary for making the respective features available. The controller 36 is also connected to a RADIUS controller 174 and to a gatekeeper controller 176. The controller 36 uses program interfaces to transmit setting information to the RADIUS controller 174 and/or to the gatekeeper controller 176 depending on the type of setting information. This setting information relates to services and/or features which are made available to a subscriber using the IP network 34. The setting information is transmitted by the RADIUS controller 174 using a conventional administration connection 184, for example using an SNMP connection, to the RADIUS server 188. The setting information is transmitted by the gatekeeper controller 176, using a conventional administration connection 186, for example using an SNMP connection, to the gatekeeper 22. Both the RADIUS server 188 and the gatekeeper 22 are network elements of the IP network 34. A media gateway 178 is provided for transmitting useful data between the IP network 34 and at least one switching office of the telecommunications network 48.

In the present exemplary embodiment, the controller 36 is implemented as a data processing system with an “IP business manager” program module. The feature controller 168, the connection controller 170, the RADIUS controller 174 and the gatekeeper controller 176 are also implemented using program modules which are processed on the same data processing system. The program modules 168, 170, 174, 176 are also used for subscriber administration in conventional telecommunications systems. To date, it has been necessary to perform the subscriber administration separately in each of these program modules 168, 170, 174, 176. This is made more difficult, in particular, by different operator interfaces and different operating principles of the individual program modules. Also, not all of these program modules have a user-friendly interface. The setting and configuration of individual services and features requires settings in a number of program modules 168, 170, 174, 176.

In the prior art, in the case of the program modules 168, 170, 174, 176 which are to be operated separately, the operator must himself check the entries for consistency. Malfunctions owing to contradictory settings in the program modules 168, 170, 174, 176 have been able to lead to malfunctions in the telecommunications system. In the present exemplary embodiment, the controller 36 can be used to make the settings easily using a clearly organized operator interface 60 for all the subscribers 26 to 32 both of the telecommunications network 48 and of the IP network 34. If the telecommunications system 10 also supports the provision of features of the telecommunications network 48 for subscribers 30, 32, of the IP network 34, these features can be set and configured using the controller 36. The controller 36 has open program interfaces to the control units 168, 170, 174, 176. Further control units also can be easily connected to the controller 36 using these program interfaces.

In other exemplary embodiments, the program modules 168, 170, 174, 176 are not processed by the same data processing system, as is the case with the program module of the controller 36. The exchange of data between the different data processing systems is then carried out using, for example, a known network connection.

Although the present invention has been described with reference to specific embodiments, those of skill in the art will recognize that changes may be made thereto without departing from the spirit and scope of the invention as set forth in the hereafter appended claims.

1. A method for subscriber administration in a variety of telecommunications networks, the method comprising the steps of:
making available first services and features to a first to a first subscriber to a line-switching communications network using the line-switching communications network;
making available second services and features to a second subscriber to a packet-switching communications network using the packet-switching communications network;
generating first setting information for the first subscriber and second setting information for the second subscriber using a controller;
transmitting the first setting information between the controller and at least a first control unit of the line-switching communications network;
transmitting the second setting information between the controller and at least a second control unit of the packet-switching communications network;
storing the transmitted first setting information and setting the corresponding services and features at the first subscriber via the first control unit; and
storing the transmitted second setting information and setting the corresponding services and features at the second subscriber via the second control unit.

2. A method for subscriber administration in a variety of telecommunications networks as claimed in claim 1, wherein the controller is a superordinate controller of the first and the second control units.

3. A method for subscriber administration in a variety of telecommunications networks as claimed in claim 1, the method further comprising the step of:
carrying out subscriber signaling of the second subscriber using a network element of the line-switching communications network which has an interface to the packet-switching communications network.

4. A method for subscriber administration in a variety of telecommunications networks as claimed in claim 3, the method further comprising the step of:
making available the services and features of the line-switching communications network to the second subscriber via the subscriber signaling.

5. A method for subscriber administration in a variety of telecommunications networks as claimed in claim 4, wherein the controller generates for the second subscriber, in addition to the second setting information, first setting information which relates to the services and features of the line-switching communications network.

6. A method for subscriber administration in a variety of telecommunications networks as claimed in claim 1, wherein the services and features of the line-switching communications network include at least one of call pick-up, call divert, call forwarding, call name display, subscriber cut-in, subscriber-dependent ringing, three-way conferencing, large-scale conferencing, holding, displaying of toll information, closed user group, private number schedule, call number identification, automatic call-back when busy, automatic call-back when no reply, call barring, call waiting and call transfer facilities.

7. A method for subscriber administration in a variety of telecommunications networks as claimed in claim 1, wherein the second setting information generated using the controller includes at least one of an alias name, gatekeeper administration and call waiting.

8. A method for subscriber administration in a variety of telecommunications networks as claimed in claim 1, wherein settings in a plurality of control units are necessary to set at least one of a service and a feature, and wherein corresponding setting information is transmitted between the controller and the respective control units.

9. A method for subscriber administration in a variety of telecommunications networks as claimed in claim 7, wherein respective control information is transmitted to control units of the respective line-switching communications network and the packet-switching communications network.

10. A method for subscriber administration in a variety of telecommunications networks as claimed in claim 1, wherein subscriber signaling is carried out in accordance with an H.323/H.450 signaling protocol in the packet-switching communications network.

11. A method for subscriber administration in a variety of telecommunications networks as claimed in claim 1, wherein subscriber signaling is carried out in accordance with a DSS 1 signaling protocol in the line-switching communications network

12. A method for subscriber administration in a variety of telecommunications networks as claimed in claim 1, wherein the packet-switching communications network is a data network based on an Internet protocol.

13. A method for subscriber administration in a variety of telecommunications networks as claimed in claim 1, wherein the respective respective services and features can be at least one of activated, deactivated and configured using at least one of the first and second setting information.

14. A method for subscriber administration in a variety of telecommunications networks as claimed in claim 1, wherein the controller includes an input unit and an output unit which can be used to respectively input and output setting information to administer the services and features.

15. A method for subscriber administration in a variety of telecommunications networks as claimed in claim 1, wherein the controller makes available a graphic user interface for inputting and outputting data.

16. A method for subscriber administration in a variety of telecommunications networks as claimed in claim 15, wherein the services and features are at least one of activated, deactivated and configured using selection lists of the graphic user interface.

17. A method for subscriber administration in a variety of telecommunications networks as claimed in claim 1, wherein the controller has access to a database with subscriber information of the first and second subscribers.

18. A method for subscriber administration in a variety of telecommunications networks as claimed in claim 17, wherein the access to the database is carried out using one of a COBRA interface and an SNMP interface of the controller.

19. A method for subscriber administration in a variety of telecommunications networks as claimed in claim 1, wherein the transmission of the setting information is carried out using a program interface between the controller and the first and second control units.

20. A method for subscriber administration in a variety of telecommunications networks as claimed in claim 19, wherein the program interface is one of a Q3 interface and an interface based on man/machine language.

21. A method for subscriber administration in a variety of telecommunications networks as claimed in claim 1, the method further comprising the step of:
assigning a plurality of subscribers to one group in the controller, wherein it is possible to assign services and features to the group.

22. A method for subscriber administration in a variety of telecommunications networks as claimed in claim 21, wherein the subscribers are subscribers to one of the line-switching communications network and the packet-switching communications network.

23. A telecommunications system for subscriber administration in a variety of telecommunications networks, comprising:
a line-switching communications network to which a first subscriber is connected, first services and features being made available to the first subscriber using the line-switching communications network;
a packet-switching communications network to which a second subscriber is connected, second services and features being made available to the second subscriber using the packet-switching communications network;
a controller for generating first setting information for the first subscriber and second setting information for the second subscriber;
a first control unit of the line-switching communications network, the first setting information being transmitted between the controller and at least the first control unit; and
a second control unit of the packet-switching communications network, the second setting information being transmitted between the controller and at least the second control unit;
wherein the first control unit stores the transmitted first setting information and sets the corresponding services and features at the first subscriber, and the second control unit stores the transmitted second setting information and sets the corresponding services and features at the second subscriber.

24. A telecommunications system for subscriber administration in a variety of telecommunications networks as claimed in claim 23, wherein subscriber signaling of the second subscriber is carried out using a network element of the line-switching communications network which has an interface to the packet-switching communications network.

25. A telecommunications system for subscriber administration in a variety of telecommunications networks, wherein the services and features of the line-switching communications network are made available to the second subscriber via subscriber signaling.

26. A telecommunications system for subscriber administration in a variety of telecommunications networks as claimed in claim 23, wherein the packet-switching communications network is a data network based on an Internet protocol.
